(19) United States
(12) Patent Application Publication
(10) Pub. No.: US 2025/0233298 A1
(43) Pub. Date: Jul. 17, 2025

(54) ANTENNA APPARATUS AND RADOME

(71) Applicants: NEC Corporation, Minato-ku, Tokyo (JP); NEC Platforms, Ltd., Kawasaki-shi, Kanagawa (JP)

(72) Inventors: Shoji MORI, Kanagawa (JP); Tetsuya SAITO, Kanagawa (JP)

(73) Assignees: NEC Corporation, Minato-ku, Tokyo (JP); NEC Platforms, Ltd., Kawasaki-shi, Kanagawa (JP)

(21) Appl. No.: 18/844,456

(22) PCT Filed: Mar. 22, 2022
(86) PCT No.: PCT/JP2022/013044

§ 371 Date: Sep. 6, 2024

(51) Int. Cl. H01Q 1/00; H01Q 1/42

(52) U.S. Cl. CPC H01Q 1/002; H01Q 1/42

(57) ABSTRACT

An antenna apparatus includes a substrate, an antenna element disposed on a front surface of the substrate, and a radome of a conductor with thermal conductivity, being configured to cover the front surface of the substrate, and having a slot formed at a position facing the antenna element. The radome includes a heat radiation fin structure formed in such a way as to protrude from an outer surface on an opposite side to the substrate side, and the heat radiation fin structure includes at least a heat radiation fin formed in such a way as to surround the slot.

### TECHNICAL FIELD

The present disclosure relates to an antenna apparatus and a radome.

### BACKGROUND ART

In general, in an apparatus (antenna apparatus) equipped with an antenna, such as an antenna-integrated base station apparatus, a resin radome is used as a radome protecting an antenna surface of an antenna. However, in the resin radome, a thickness of the radome needs be increased in order to enhance durability. Thus, in recent years, as disclosed in Patent Literature 1, it has been studied to protect an antenna surface by using a housing made of a conductor instead of the resin radome.

### CITATION LIST

### Patent Literature

[Patent Literature 1] Japanese Unexamined Patent Application Publication No. 2012-175422

### SUMMARY OF INVENTION

### Technical Problem

Incidentally, for reliability improvement, an antenna apparatus is required to efficiently radiate heat generated within the apparatus to an outside. However, Patent Literature 1 has no description relating to heat radiation. Therefore, there is a problem that, when attempting to achieve an antenna apparatus by using the technique disclosed in Patent Literature 1, it is necessary to further attach a heat radiation mechanism such as a heat radiation fin to the antenna apparatus using a housing made of a conductor, and, as a result, the antenna apparatus increases in size. Note that, as the number of antennas included in an antenna apparatus becomes large, the number of heat generating components in the antenna apparatus tends to also become large, and, therefore, an increase in size of the antenna apparatus is considered to become significant.

One object of the present disclosure has been made in order to solve the problem described above, and is to provide an antenna apparatus and a radome that are capable of suppressing an increase in size of an antenna apparatus.

### Solution to Problem

An antenna apparatus according to a first aspect of the present disclosure includes:
a substrate;
an antenna element disposed on a front surface of the substrate; and
a radome of a conductor with thermal conductivity, being configured to cover the front surface of the substrate, and having a slot formed at a position facing the antenna element, wherein
the radome includes a heat radiation fin structure formed in such a way as to protrude from an outer surface on an opposite side to the substrate side, and
the heat radiation fin structure includes at least a heat radiation fin formed in such a way as to surround the slot.

An antenna apparatus according to a second aspect of the present disclosure includes:
a substrate;
a plurality of antenna elements disposed on a front surface of the substrate; and
a radome of a conductor with thermal conductivity, being configured to cover the front surface of the substrate, and having a plurality of slots each formed at a position facing each of the plurality of antenna elements, wherein
the radome includes a heat radiation fin structure formed in such a way as to protrude from an outer surface on an opposite side to the substrate side, and
the heat radiation fin structure includes at least a plurality of heat radiation fins each formed in such a way as to surround each of the plurality of slots.

A radome according to a third aspect of the present disclosure is
a radome of a conductor with thermal conductivity, having a slot formed at a position facing an antenna element in a state of covering a front surface of a substrate on which the antenna element is disposed,
the radome includes a heat radiation fin structure formed in such a way as to protrude from an outer surface on an opposite side to the substrate side, and
the heat radiation fin structure includes at least a heat radiation fin formed in such a way as to surround the slot.

### Advantageous Effects of Invention

According to the present disclosure, it is possible to provide an antenna apparatus and a radome that are capable of suppressing an increase in size of an antenna apparatus.

### BRIEF DESCRIPTION OF DRAWINGS

FIG. 1 is a schematic top view of an antenna apparatus according to a first example embodiment;

FIG. 2 is a view enlarging a part of a radome provided in the antenna apparatus illustrated in FIG. 1:

FIG. 3 is a schematic cross-sectional view of the antenna apparatus according to the first example embodiment;

FIG. 4 is a diagram for describing a flow of heat radiation in the antenna apparatus according to the first example embodiment;

FIG. 5 is a view enlarging a part of an antenna apparatus according to a first modification example:

FIG. 6 is a view enlarging a part of an antenna apparatus according to a second modification example:

FIG. 7 is a schematic cross-sectional view of a part of a heat radiation fin group provided in the antenna apparatus illustrated in FIG. 6:

FIG. 8 is a view enlarging a part of an antenna apparatus according to a third modification example:

FIG. 9 is a view enlarging a part of an antenna apparatus according to a fourth modification example:

FIG. 10 is a view enlarging a part of an antenna apparatus according to a fifth modification example:

FIG. 11 is a schematic top view of an antenna apparatus according to a second example embodiment:

FIG. 12 is a schematic top view of the antenna apparatus according to the second example embodiment:

FIG. 13 is a schematic top view of an antenna apparatus according to a third example embodiment; and

FIG. 14 is a diagram for describing a flow of heat radiation in an antenna apparatus according to a third example embodiment.

### EXAMPLE EMBODIMENT

Hereinafter, example embodiments of the present disclosure will be described with reference to the drawings. Note that, the following description and the drawings are omitted and simplified as appropriate for clarity of description. In addition, in the following drawings, the same elements are denoted by the same reference signs, and redundant descriptions are omitted as necessary. In each example embodiment, a deviation in a direction being parallel, horizontal, vertical, and the like is allowed to an extent that an effect of the present disclosure is not impaired. In addition, in the drawings for describing the example embodiments, when a direction is not specifically described, a direction on the drawings is referred to.

### Preliminary Consideration Leading to the Example Embodiment

First, before describing details of the example embodiments, details of preliminary consideration leading to the example embodiments will be described. An active antenna system (AAS) is known as an antenna apparatus used for fifth-generation mobile communication. The AAS enables flexible beamforming, multi user-multiple input multiple output (MU-MIMO), massive-MIMO, and the like by providing a transceiver for each of a plurality of antenna elements constituting a super multi-element antenna array. As a result, since the AAS can spatially multiplex and collectively transmit a radio signal of a plurality of communication terminals and a plurality of layers, a cell throughput can be greatly improved, and frequency utilization efficiency can be improved.

In the AAS having a full digital beamforming function capable of MU-MIMO, a transceiver including an analog to digital converter (ADC), a digital to analog converter (DAC), a transmitter and receiver (TRX), and a radio frequency frontend (RF frontend) is provided associated to each antenna. Thus, in the AAS, as the number of antennas becomes large, the number of transceivers becomes large, and electric power consumption also increases accordingly.

As described above, in general, in an apparatus (antenna apparatus) equipped with an antenna, such as an antenna-integrated base station apparatus, a resin radome is used as a radome protecting an antenna surface of an antenna. However, there is a possibility that the resin radome hinders when heat generated in the antenna apparatus is radiated to an outside. Thus, in the AAS using a resin radome, heat radiation to an outside is not performed from the antenna surface, but a radiator fin is provided in a housing provided on a rear surface side on an opposite side to the antenna surface, and heat radiation to an outside is performed from the radiator fin. Therefore, the AAS using a resin radome needs to be additionally provided with a heat radiation fin such as a radiator fin, and is thereby led to an increase in size.

Meanwhile, a forced air cooling system and a natural air cooling system are known as a cooling system for suppressing an increase in temperature of an internal device. The forced cooling system is a system in which an internal device is cooled by pushing external air into the internal device or sucking overheated air out of the internal device, by providing a fan. The natural air cooling system is a system in which heat from an internal device is diffused, the heat is guided to a radiator fin, and then heat radiation efficiency is improved by securing a number of fins and a fin length and thereby expanding a heat radiation area with respect to an external environment.

Since the AAS adopting the forced cooling system enables achievement in improvement of heat radiation efficiency and a decrease in size, but needs to drive a fan continuously, a failure due to continuous driving occurs and leads to a decrease in reliability, and immediate maintenance at a time of the failure is required. In addition, the AAS adopting the forced cooling system, when deployed in an urban area in particular, has a possibility of causing unwanted noise due to rotation noise of the fan. Thus, the AAS is more likely to adopt the natural cooling system than the forced cooling system. Therefore, even in the AAS adopting the natural cooling system, it is desired to increase the heat radiation efficiency while achieving a decrease in size and weight reduction. According to the present disclosure, an antenna apparatus such as an AAS and a radome capable of increasing the heat radiation efficiency of the AAS while suppressing an increase in size is achieved.

### First Example Embodiment

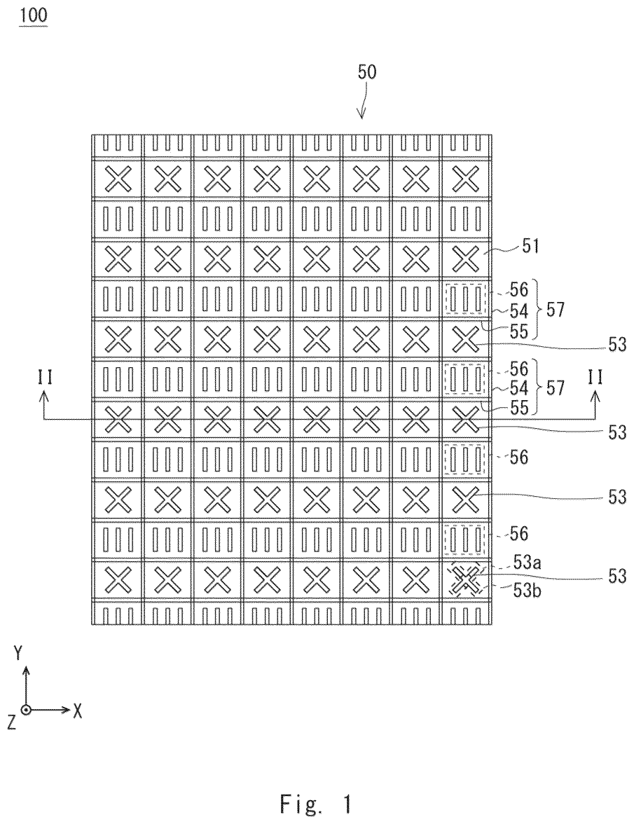

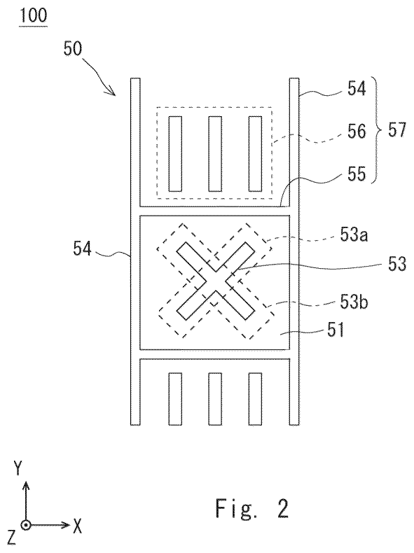

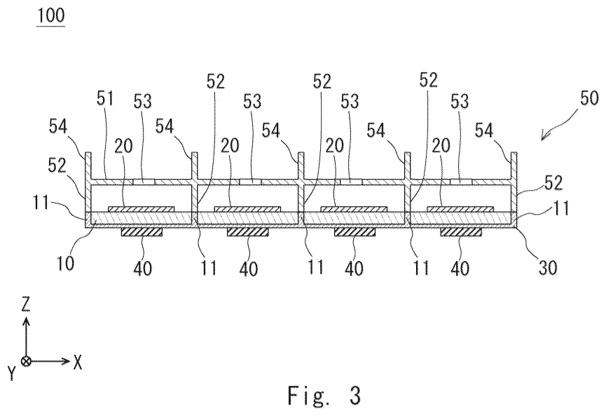

FIG. 1 is a schematic top view of an antenna apparatus 100 according to a first example embodiment. FIG. 2 is a view in which a part of a radome 50 provided in the antenna apparatus 100 illustrated in FIG. 1 is enlarged. FIG. 3 is a schematic cross-sectional view of the antenna apparatus 100 according to the first example embodiment. Note that, FIG. 3 illustrates a cross-sectional view of the antenna apparatus 100 illustrated in FIG. 1 when the antenna apparatus 100 is cut along the cutting line II-II.

The antenna apparatus 100 is an antenna array including a plurality of antenna elements, and may be, for example, an AAS. The antenna apparatus 100 includes a large number of antenna elements, and may therefore be referred to as an antenna system. As illustrated in FIGS. 1 to 3, the antenna apparatus 100 includes the substrate 10, a plurality of antenna elements 20, a ground layer 30, a plurality of heat generating components 40, and a radome 50.

First, a specific configuration of the antenna apparatus 100 will be described with reference to FIG. 3. As illustrated in FIG. 3, the substrate 10 is provided with an electrical wiring pattern, and a plurality of antenna elements 20 are disposed on a first surface of the substrate 10 in a Z-axis positive direction side. Note that, since the first surface faces in a direction of radio wave radiation of the antenna element 20, it may be referred to as a front surface or a top surface, and a second surface of the substrate 10 on an opposite side to the first surface may be referred to as a back surface or a bottom surface. The plurality of antenna elements 20 are disposed away from each other by a predetermined distance in an X-axis direction on the front surface of the substrate 10. Each of the plurality of antenna elements 20 is electrically connected to the ground layer 30 and the radome 50 via a ground line provided on the front surface of the substrate 10. Note that, although omitted illustrating the drawings, the plurality of antenna elements 20 is disposed away from each other by a predetermined interval in a Y-axis direction as well.

In the substrate 10, a plurality of thermal vias 11 being through holes penetrating from the front surface to the back surface of the substrate 10 is formed. The plurality of thermal vias 11 are disposed in a vicinity of the plurality of antenna elements 20. In addition, the plurality of thermal via 11 are formed in such a way as to surround the plurality of antenna elements 20 when viewed from above (i.e., when the front surface of the substrate 10 is viewed in a Z-axis negative direction). Note that, the plurality of thermal vias 11 are formed in such a way as to surround all of the plurality of antenna elements 20 in the present example embodiment, but are not limited thereto, and, for example, may be formed in such a way as to surround some of the plurality of antenna elements 20.

Each of the plurality of antenna elements 20 may be disposed at an equal interval with the adjacent antenna element 20. Each of the plurality of antenna elements 20 is an antenna element that is supplied with power, and is, for example, a patch antenna. Each of the plurality of antenna elements 20 is a primary resonator in which a transceiver (not illustrated) disposed on the back surface of the substrate 10 performs transmission and reception of a signal to and from an external communication apparatus. The antenna apparatus 100 radiates, by dual resonance of the plurality of antenna elements 20 and a plurality of slot antenna elements constituted by a plurality of slots 53 to be described later, a radio wave from the plurality of slot antenna elements to a direction directing by the front surface of the substrate 10, and performs transmission and reception of a signal to and from an external communication apparatus positioned in the direction.

The same number of heat generating components 40 as the number of antenna elements 20 are disposed on the back surface of the substrate 10 via the ground layer 30 made of copper foil or the like. Each of the plurality of heat generating components 40 may be, for example, an amplifier (AMP). Each of the plurality of heat generating components 40 may be disposed at a position associated with each of the plurality of antenna elements 20. Specifically, each of the heat generating components 40 and the antenna element 20 associated with the heat generating component 40 may be disposed in such a way as to sandwich the substrate 10 in a Z-axis direction. Herein, each of the heat generating components 40 is electrically connected to the antenna element 20 associated with the heat generating component 40. In addition, each of the heat generating components 40 is thermally connected to the radome 50 to be described later, via the ground layer 30. In other words, the antenna apparatus 100 is configured in such a way that heat generated by each of the heat generating components 40 is transferred to the radome 50 via the thermal via 11 associated with the heat generating component 40. Each of the thermal vias 11 serves as a heat radiation path that transfers, to the radome 50, the heat generated by the heat generating component 40 associated with the thermal via 11.

Note that, although omitted illustrating in FIG. 3, each of the heat generating components 40 is connected to an external circuit via at least one of a signal line and a control line other than ground of the substrate 10. Further, a ground pad (GND PAD1) on the back surface of each of the heat generating components 40 or a ground pin (GND Pin) disposed around each of the heat generating components 40 is connected by reflow processing using a surface mount technology (SMT) or the like to a ground pattern surface (GND pattern) on the substrate 10 or a ground terminal portion (GND PAD2) for connecting a ground pin. A connection portion between the grounds is connected to the ground layer 30 not only for electrical grounding but also in order to form a heat radiation path.

The radome 50 is formed of a conductor with thermal conductivity. For example, the radome 50 is formed of aluminum, silver, copper, or metal such as an alloy containing any of the substances. Note that, for the radome 50, a resin housing whose surface is plated with a conductor having thermal conductivity may be used. The radome 50 is fixed to the substrate 10 in a state of covering the front surface of the substrate 10, and serves as a protective member that protects the plurality of antenna elements 20 disposed on the front surface of the substrate 10. Specifically, the radome 50 includes a planar portion 51 and a wall portion 52.

The planar portion 51 is disposed in parallel with the substrate 10 away from the substrate 10 by a distance corresponding to a height of the wall portion 52 in a state of covering the front surface of the substrate 10. Herein, in the planar portion 51, the same number of slots 53 as the number of the antenna elements 20 are formed at positions facing the plurality of antenna elements 20 disposed on the front surface of the substrate 10. Each of the plurality of slots 53 is formed at a position in the Z-axis positive direction of each of the plurality of antenna elements 20. Each of the slots 53 functions as a slot antenna element. Each of the slot antenna elements is a sub-resonator having a same resonance frequency as that of the antenna element 20 associated with the slot antenna element, and functions as an antenna element that performs combination resonance with the antenna element 20 and thereby widens a frequency band. In the antenna apparatus 100, each of the slots 53 functions as the slot antenna element, and, thereby, it is possible to transmit and receive a signal to and from a communication apparatus in a direction to which an outer surface on the opposite side to the front surface side of the substrate 10 is directed, by using a wider frequency band.

In addition, the planar portion 51 includes at least a plurality of first heat radiation fins 54 protruding from an outer surface on the opposite side of the substrate 10 side. Each of the first heat radiation fins 54 is a fin for radiating heat generated in the heat generating component 40 to an outside. Each of the first heat radiation fins 54 is disposed in the vicinity of one of the plurality of slots 53 functioning as a slot antenna element. Each of the first heat radiation fins 54 protrudes from the outer surface of the planar portion 51 in the Z-axis positive direction and a vertical direction. In other words, each of the first heat radiation fins 54 protrudes from the outer surface of the planar portion 51 in such a way that the wall portion 52 extends in the Z-axis positive direction. Each of the first heat radiation fins 54 transfers heat of the heat generating component 40 transferred from the wall portion 52 to the air, and thereby radiates the heat of the heat generating component 40 to the outside of the antenna apparatus 100. In other words, the outside air removes heat of the heat generating component 40 transferred from the wall portion 52 by touching a front surface of each of the first heat radiation fins.

The wall portion 52 is provided in such a way as to extend from the inner surface of the planar portion 51 on the substrate 10 side in the Z-axis negative direction and in the vertical direction. The wall portion 52 is provided in such a way as to connect to the substrate 10 and surround each of the antenna elements 20, in a state where the radome 50 covers the front surface of the substrate 10. Specifically, first, the wall portion 52 is provided in such a way as to connect to an area between the adjacent antenna elements 20 and an area in the vicinity of an end portion of the substrate 10 on the front surface of the substrate 10 in a state where the radome 50 covers the front surface of the substrate 10. Herein, since the wall portion 52 is connected to the substrate 10 in a state where the radome 50 covers the substrate 10, and is thereby thermally connected to the plurality of heat generating components 40 disposed on the back surface of the substrate 10, heat of the plurality of heat generating components 40 can be transferred to at least the plurality of first heat radiation fins 54. Specifically, the wall portion 52 is provided at a position to cover an end portion of each of the plurality of thermal vias 11 formed on the substrate 10 in a state where the radome 50 covers the substrate 10. Thereby, the wall portion 52 can receive heat of the plurality of heat generating components 40 via the plurality of thermal vias 11 and transfer the heat to the plurality of first heat radiation fins 54.

In addition, as described above, since the wall portion 52 is provided in such a way as to connect to the area between two adjacent antenna elements 20 on the front surface of the substrate 10, a mutual influence between the plurality of antenna elements 20 can be reduced, and, as a result, an antenna characteristic of the antenna apparatus 100 can be improved. In addition, since multiple resonance that may occur in a space inside a housing made of a conductor can be suppressed by providing the wall portion 52, attachment of an absorber for suppressing multiple resonance and the like are no longer needed, and, as a result, development costs and a manufacturing cost are suppressed.

Note that, FIG. 3 is a cross-sectional view of the antenna apparatus 100 when the antenna apparatus 100 illustrated in FIG. 1 is cut along the cutting line II-II passing through a center of each of the plurality of slots 53 arranged in the X-axis direction, but a cross-sectional view of the antenna apparatus 100 when the antenna apparatus 100 illustrated in FIG. 1 is cut along a cutting line passing through the center of each of the slots 53 arranged in the Y-axis direction is also similar except for the heat radiation fin, and therefore illustration thereof is omitted.

Next, the planar portion 51 of the radome 50 will be described with reference to FIGS. 1 and 2.

As illustrated in FIG. 1, the planar portion 51 further includes, in addition to the plurality of slots 53 and the plurality of first heat radiation fins 54 described above, the plurality of second heat radiation fins 55 and the plurality of third heat radiation fins 56. Note that, the plurality of first heat radiation fins 54, the plurality of second heat radiation fins 55, and the plurality of third heat radiation fins 56 are also collectively referred to as a heat radiation fin group (heat radiation fin structure) 57.

Referring to FIG. 1, each of the slots 53 has an X-shape. A shape of each of the slots 53 will be described in more detail using FIG. 2. Note that, FIG. 2 illustrates only one slot 53 among the plurality of slots 53 formed in the planar portion 51 of the radome 50, and the heat radiation fin group 57 around the slot.

As illustrated in FIG. 2, the slot 53 includes a first opening 53a extending in a first direction, for example, having an angle with the X-axis of 45 degrees, and a second opening 53b extending in a second direction being different from the first direction, for example, having an angle with the X-axis of 135 degrees (−45 degrees). The first opening 53a is open in a rectangular shape in the planar portion 51, with the first direction as a longitudinal direction and the second direction as a lateral direction. The second opening 53b is open in a rectangular shape in the planar portion 51 with the second direction as the longitudinal direction and the first direction as the lateral direction. The first opening 53a and the second opening 53b intersect each other at, for example, a center position of the slot 53, and thereby form an opening that is open in an X-shape. Each of the slots 53 has an opening that is open in an X-shape, and can thereby function as a slot antenna element capable of transmitting and receiving two polarized waves.

Note that, understandably, the angle formed between the first direction and the X-axis and the angle formed between the second direction and the X-axis are not limited to the above, and may be set to any angle as long as the angles are not the same as each other. In addition, both the shapes of the first opening 53a and the second opening 53b may not be rectangular. In addition, each of the slots 53 may function as a slot antenna element capable of receiving a plurality of three or more polarized waves by, for example, combining an additional opening with the first opening 53a and the second opening 53b.

The heat radiation fin group 57 is formed in such a way as to protrude from the outer surface of the planar portion 51 on the opposite side to the substrate 10 side. In other words, the plurality of first heat radiation fins 54, the plurality of second heat radiation fins 55, and the plurality of third heat radiation fins 56 are formed in such a way as to protrude from the outer surface of the planar portion 51 on the opposite side to the substrate 10 side. The heat radiation fin group 57 is disposed in the vicinity of the plurality of slots 53 functioning as a slot antenna element in order to increase heat radiation efficiency.

Each of the first heat radiation fins 54 is disposed between two slots 53 adjacent to each other in the X-axis direction, and extends from an end portion of the planar portion 51 in the Y-axis negative direction to an end portion of the planar portion 51 in the Y-axis positive direction. Note that, a shape of each of the first heat radiation fins 54 illustrated in FIG. 1 is one example, and thus another shape may be used.

Each of the second heat radiation fins 55 is disposed between two slots 53 adjacent to each other in the Y-axis direction, and extends from an end portion of the planar portion 51 in the X-axis negative direction to an end portion of the planar portion 51 in the X-axis positive direction.

Herein, the plurality of first heat radiation fins 54 and the plurality of second heat radiation fins 55 are formed in such a way as to surround the plurality of slots 53 when viewed from above (i.e., when the planar portion 51 of the radome 50 is viewed in the Z-axis negative direction). In other words, when viewed from above, each of the slots 53 is surrounded by a part of a pair of first heat radiation fins 54 formed in such a way as to sandwich the slot 53 in the X-axis direction, and a part of the first heat radiation fin 54 formed in such a way as to sandwich the slot 53 in the Y-axis direction. Thereby, since current generated in the vicinity of each of the slots 53 not only flows along the pair of first heat radiation fins 54 but also flows along the pair of second heat radiation fins 55 in a direction different from that of the pair of first heat radiation fins 54, a direction of the current is dispersed compared to a case where the current flows in only one direction. Thereby, an influence of the current on the direction of a polarized wave transmitted and received in each of the slots 53 is suppressed. In other words, an unintended fluctuation in a direction of a polarized wave transmitted and received in each of the slots 53 due to the current is suppressed. In particular, in each of the slots 53, since transmission and reception of two polarized waves are performed, directions of the two polarized waves are kept in an orthogonal state by suppressing an unintentional fluctuation in directions of the two polarized waves, and, as a result, deterioration of isolation between two polarized waves is suppressed.

Note that, portions of the heat radiation fins 54 and 55 surrounding each of the slots 53 are preferably formed in such a way as to be point symmetrical about a center (center portion) of the slot 53 when viewed from above. In the present example embodiment, as illustrated in FIG. 2, the portions of the heat radiation fins 54 and 55 surrounding each of the slots 53 are formed into a rectangular shape in such a way as to be point symmetrical about the center of the slot 53 when viewed from above. Herein, since the portions of the heat radiation fins 54 and 55 surrounding each of the slots 53 constitute a closed circuit, and current flowing through each of the facing radiation fins among the portions of the heat radiation fins 54 and 55 surrounding the slot 53 is brought into a reversed direction, an influence of the current flowing through each of the facing radiation fins on a polarized wave is offset. Thereby, deterioration of isolation between two polarized waves in each of the slots 53 is effectively suppressed.

Each of the third heat radiation fins 56 is disposed between two slots 53 adjacent to each other in the Y-axis direction. Each of the third heat radiation fins 56 is constituted of three rectangular radiation fins with the Y-axis direction as a longitudinal direction and the X-axis direction as a lateral direction. Note that, each of the third heat radiation fins 56 is not limited to a case of being constituted of three heat radiation fins, and may be constituted of any number of one or more radiation fins. In addition, a shape of each of the third heat radiation fins 56 is one example, and thus another shape may be used.

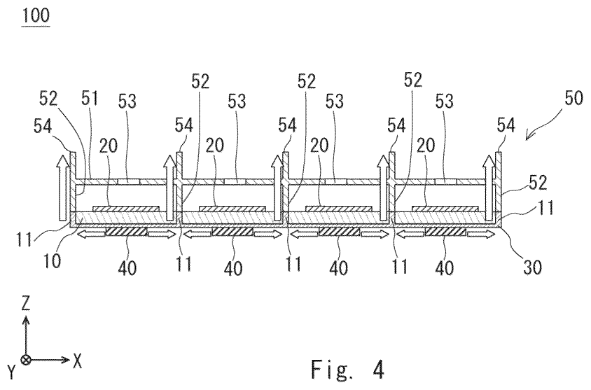

Next, a flow of heat radiation in the antenna apparatus 100 will be described with reference to FIG. 4. FIG. 4 is a diagram for describing a flow of heat radiation in the antenna apparatus 100. FIG. 4 is a diagram adding a white arrow illustrating a flow of heat generated by the plurality of heat generating components 40 to a schematic cross-sectional view illustrated in FIG. 3. As illustrated in FIG. 4, heat generated in the plurality of heat generating components 40 is transferred to the wall portion 52 of the radome 50 having thermal conductivity via the ground layer 30 and the plurality of thermal vias 11. Then, the heat of the wall portion 52 is transferred to the heat radiation fin group 57 formed on the front surface of the radome 50, and is then radiated to the outside.

As described above, the antenna apparatus 100 according to the present example embodiment includes the radome 50 of a conductor with thermal conductivity that protects the plurality of antenna elements 20 and also functions as a slot antenna. Herein, the radome 50 includes at least the wall portion 52 that receives heat generated within the antenna apparatus 100, and the heat radiation fin group (heat radiation fin structure) 57 that radiates, to the outside, the heat received by the wall portion 52. Thereby, the antenna apparatus 100 according to the present example embodiment can efficiently radiate heat generated within the apparatus to the outside, without providing a heat radiation mechanism in addition to the radome 50. In other words, the antenna apparatus 100 according to the present example embodiment can efficiently radiate heat generated within the apparatus to the outside while suppressing an increase in scale.

In addition, in the antenna apparatus 100 according to the present example embodiment, the heat radiation fin group 57 includes at least a heat radiation fin formed in such a way as to surround each of the slots 53. Thereby, since a direction of current generated in the vicinity of each of the slots 53 is dispersed, an unintended fluctuation in a direction of a polarized wave transmitted and received in each of the slots 53 due to the current is suppressed. In particular, in each of the slots 53, since transmission and reception of two polarized waves are performed, an unintended fluctuation in directions of the two polarized waves is suppressed, the directions of the two polarized waves are kept in an orthogonal state, and, thereby, deterioration of isolation between two polarized waves is suppressed.

Note that, in an antenna apparatus, when a resin radome is used in order to protect an antenna surface, a front surface of the antenna apparatus cannot be used for heat radiation. Thus, when a resin radome is used in the antenna apparatus, it is necessary to provide a heat radiation fin on a rear surface of the antenna apparatus. In contrast, in the antenna apparatus 100 according to the present example embodiment, since the radome 50 having thermal conductivity is used, a heat radiation mechanism can be provided on the front surface of the antenna apparatus 100, and it is not necessary to provide a heat radiation fin on the rear surface of the antenna apparatus 100. Therefore, the antenna apparatus 100 can efficiently radiate heat generated within the apparatus to the outside while suppressing an increase in scale.

In addition, in an antenna apparatus, when a resin radome is used in order to protect the antenna surface, it is necessary to secure a certain amount of space between the antenna element and the resin radome in order to appropriately adjust the antenna characteristic. In contrast, in the antenna apparatus 100 according to the first example embodiment, since the slot antenna element and the radome 50 are formed of the same member, it is not necessary to provide a space between the antenna element 20 and the radome 50. Thus, an increase in scale can be further suppressed in the antenna apparatus 100.

Note that, in the antenna apparatus 100 according to the present example embodiment, an additional radiation fin group may be provided on a rear surface side of the antenna apparatus 100, in addition to the heat radiation fin group 57. Thereby, the antenna apparatus 100 can more efficiently radiate heat generated within the apparatus to the outside. In addition, in the antenna apparatus 100 according to the present example embodiment, correction of antenna pattern distortion due to an influence of mutual coupling between the plurality of antenna elements 20 may be performed by adjusting a dimension and a positional relationship of the heat radiation fin group 57. Thereby, an antenna characteristic can be further improved in the antenna apparatus 100.

In addition, in the present example embodiment, a case has been described as an example in which the plurality of slots 53 are formed in the radome 50 and a heat radiation fin is formed in such a way as to surround each of the slots 53, but the present invention is not limited thereto. One slot 53 may be formed in the radome 50, and a heat radiation fin may be formed in such a way as to surround the slot 53.

Next, several modification examples of the antenna apparatus 100 will be described.

### First Modification Example of Antenna Apparatus 100

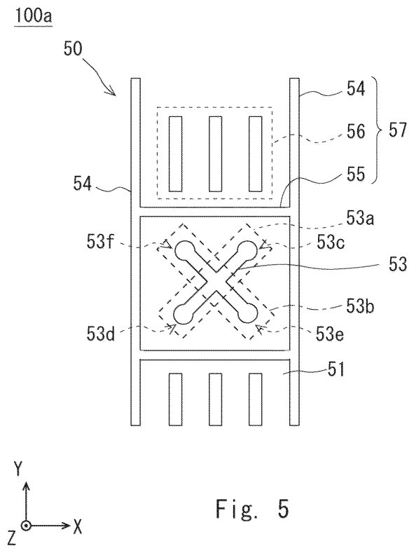

In the antenna apparatus 100, the shape of each of the slots 53 is an X-shape. In contrast, in an antenna apparatus 100a being a first modification example of the antenna apparatus 100, a shape of each of slots 53 is a so-called dog-bone shape. A description will be given below by using FIG. 5.

FIG. 5 is a view in which a part of the antenna apparatus 100a according to a first modification example is enlarged. Note that, FIG. 5 only illustrates one slot 53 among the plurality of slots 53 formed in a planar portion 51 of a radome 50, and a heat radiation fin group 57 around the slot 53. Since the antenna apparatus 100a is similar to the antenna apparatus 100 except for the shape of each of the slots 53, description thereof will be omitted.

Similarly to a case of the slot 53 illustrated in FIG. 2, the slot 53 illustrated in FIG. 5 includes a first opening 53a extending in a first direction, and a second opening 53b extending in a second direction. The first opening 53a and the second opening 53b intersect, for example, at a center position of the slot 53, and thereby form an opening that opens in an X-shape. Herein, in the slot 53 illustrated in FIG. 5, unlike a case of the slot 53 illustrated in FIG. 2, both ends of the first opening 53a and both ends of the second opening 53b are widened.

More specifically, in each of an end portion 53c and an end portion 53d that are both ends of the first opening 53a, a width in a direction perpendicular to the first direction (the second direction in this example) is wider than a width of a part other than both ends of the first opening 53a. In each of the end portion 53e and the end portion 53f that are both ends of the second opening 53b, a width in a direction perpendicular to the second direction (the first direction in this example) is wider than that of a part other than both ends of the second opening 53b.

The antenna apparatus 100a according to the first modification example can provide an advantageous effect similar to that of the antenna apparatus 100. Further, by adopting a shape illustrated in FIG. 5 as a shape of each of the slots 53, the antenna apparatus 100a can widen a frequency band used for transmission and reception.

### Second Modification Example of Antenna Apparatus 100

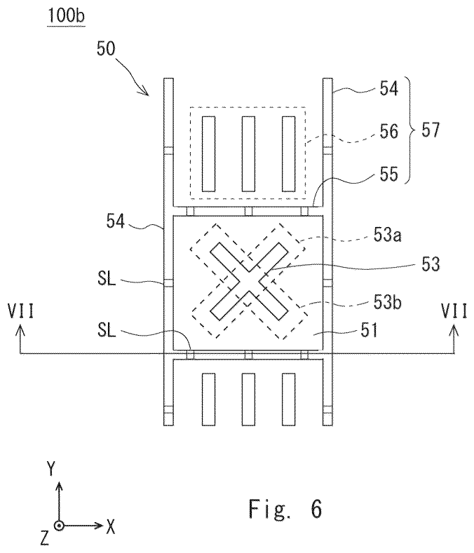

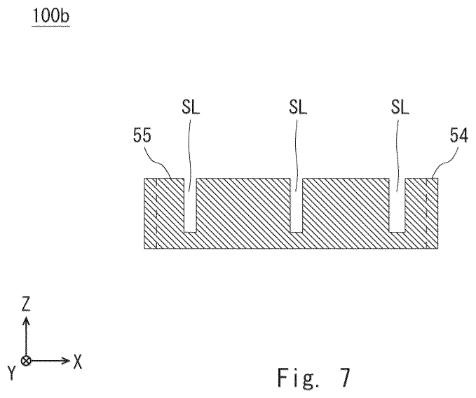

FIG. 6 is a view in which a part of an antenna apparatus 100b being a second modification example of the antenna apparatus 100 is enlarged. Note that, FIG. 6 illustrates only one slot 53 among a plurality of slots 53 formed in a planar portion 51 of a radome 50, and a heat radiation fin group 57 around the slot. In addition, FIG. 7 is a schematic cross-sectional view of a part of the heat radiation fin group 57 provided in the antenna apparatus 100b. Note that, FIG. 7 illustrates a cross section of the heat radiation fin group 57 provided in the antenna apparatus 100b when the antenna apparatus 100b illustrated in FIG. 6 is cut along a cutting line VII-VII. Since the antenna apparatus 100b is similar to the antenna apparatus 100 except for a shape of the heat radiation fin group 57, description thereof will be omitted.

As illustrated in FIG. 6, the heat radiation fin group 57 is provided with a plurality of such slits SL that a flow of current is not blocked. Thereby, water adhering to an outer surface of the radome 50 flows out of the radome 50 via the slit SL without remaining on the outer surface of the radome 50.

The antenna apparatus 100b according to the second modification example can provide an advantageous effect equivalent to that of the antenna apparatus 100. Further, in the antenna apparatus 100b, since the heat radiation fin group 57 is provided with the plurality of slits SL, water adhering to the outer surface of the radome 50 flows out of the radome 50 via the slits SL without remaining on the outer surface of the radome 50. Thereby, the antenna apparatus 100b can prevent corrosion and the like of the radome 50 caused by remaining of water on the outer surface of the radome 50.

### Third Modification Example of Antenna Apparatus 100

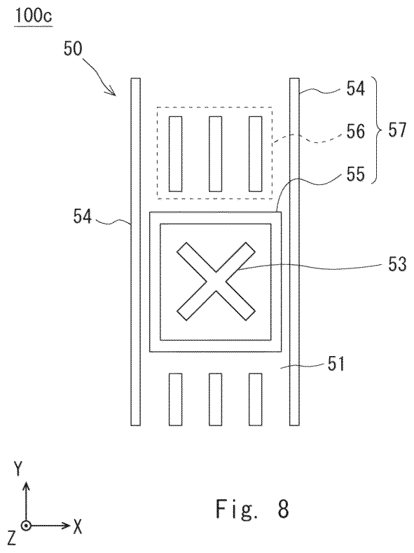

FIG. 8 is a view in which a part of an antenna apparatus 100c being a third modification example of the antenna apparatus 100 is enlarged. Note that, FIG. 8 illustrates only one slot 53 among a plurality of slots 53 formed in a planar portion 51 of a radome 50, and a heat radiation fin group 57 around the slot. Since the antenna apparatus 100c is similar to the antenna apparatus 100 except for a shape of the heat radiation fin group 57, description thereof will be omitted.

In the heat radiation fin group 57 illustrated in FIG. 8, a shape of a heat radiation fin 55 is different compared to that of the heat radiation fin group 57 illustrated in FIG. 2. Specifically, in the heat radiation fin group 57 illustrated in FIG. 2, the heat radiation fins 54 and 55 are formed in such a way as to surround the slot 53, whereas, in the heat radiation fin group 57 illustrated in FIG. 8, only the heat radiation fin 55 is formed in such a way as to surround the slot 53.

Referring to FIG. 8, the heat radiation fin 55 surrounding the slot 53 is formed into a rectangular shape in such a way as to be point symmetrical about a center of the slot 53 when viewed from above. Herein, since the heat radiation fin 55 surrounding the slot 53 constitutes a closed circuit, and current flowing through each of the facing radiation fins of the heat radiation fin 55 surrounding the slot 53 is brought into a reversed direction, an influence of the current flowing through each of the facing radiation fins on a polarized wave is offset. Thereby, deterioration of isolation between two polarized waves in each of the slots 53 is effectively suppressed.

The antenna apparatus 100c according to the third modification example can provide an advantageous effect equivalent to that of the antenna apparatus 100. Note that, understandably, a plurality of slits SL may be provided in the heat radiation fin group 57 provided in the antenna apparatus 100c.

### Fourth Modification Example of Antenna Apparatus 100

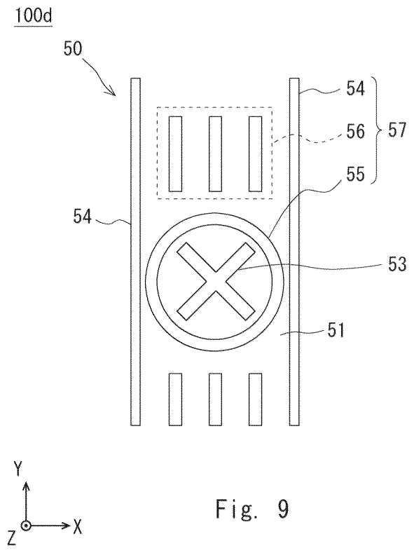

FIG. 9 is a view in which a part of an antenna apparatus 100d being a fourth modification example of the antenna apparatus 100 is enlarged. Note that, FIG. 9 illustrates only one slot 53 among a plurality of slots 53 formed in a planar portion 51 of a radome 50, and a heat radiation fin group 57 around the slot. Since the antenna apparatus 100d is similar to the antenna apparatus 100 except for a shape of the heat radiation fin group 57, description thereof will be omitted.

In the heat radiation fin group 57 illustrated in FIG. 9, a shape of a heat radiation fin 55 is different compared to that of the heat radiation fin group 57 illustrated in FIG. 2. Specifically, in the heat radiation fin group 57 illustrated in FIG. 2, the heat radiation fins 54 and 55 are formed in such a way as to surround the slot 53, whereas, in the heat radiation fin group 57 illustrated in FIG. 9, only the heat radiation fin 55 is formed in such a way as to surround the slot 53.

Referring to FIG. 9, the heat radiation fin 55 surrounding the slot 53 is formed into a circular shape in such a way as to be point symmetrical about a center of the slot 53 when viewed from above. Herein, since the heat radiation fin 55 surrounding the slot 53 constitutes a closed circuit, and current flowing through each of the facing radiation fins of the heat radiation fin 55 surrounding the slot 53 is brought into a reversed direction, an influence of the current flowing through each of the facing radiation fins on a polarized wave is offset. Thereby, deterioration of isolation between two polarized waves in each of the slots 53 is effectively suppressed.

The antenna apparatus 100d according to the fourth modification example can provide an advantageous effect equivalent to that of the antenna apparatus 100. Note that, understandably, a plurality of slits SL may be provided in the heat radiation fin group 57 provided in the antenna apparatus 100d. In addition, each of the radiation fins 55 may be formed integrally with the heat radiation fin 54 associated with the heat radiation fin 55.

### Fifth Modification Example of Antenna Apparatus 100

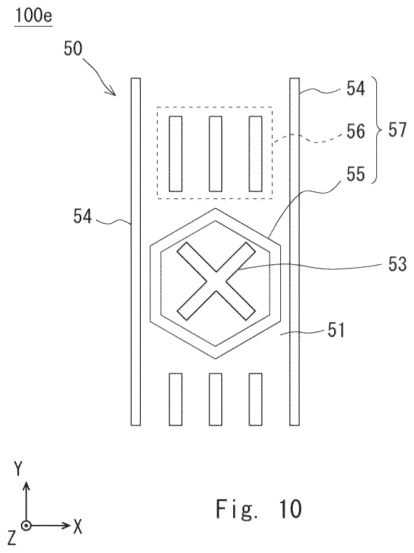

FIG. 10 is a view in which a part of an antenna apparatus 100e being a fifth modification example of the antenna apparatus 100 is enlarged. Note that, FIG. 10 illustrates only one slot 53 among a plurality of slots 53 formed in a planar portion 51 of a radome 50, and a heat radiation fin group 57 around the slot. Since the antenna apparatus 100e is similar to the antenna apparatus 100 except for a shape of the heat radiation fin group 57, description thereof will be omitted.

In the heat radiation fin group 57 illustrated in FIG. 10, a shape of a heat radiation fin 55 is different compared to that of the heat radiation fin group 57 illustrated in FIG. 2. Specifically, in the heat radiation fin group 57 illustrated in FIG. 2, the heat radiation fins 54 and 55 are formed in such a way as to surround the slot 53, whereas, in the heat radiation fin group 57 illustrated in FIG. 10, only the heat radiation fin 55 is formed in such a way as to surround the slot 53.

Referring to FIG. 10, the heat radiation fin 55 surrounding the slot 53 is formed into a hexagonal shape in such a way as to be point symmetrical about a center of the slot 53 when viewed from above. Herein, since the heat radiation fin 55 surrounding the slot 53 constitutes a closed circuit, and current flowing through each of the facing radiation fins of the heat radiation fin 55 surrounding the slot 53 is brought into a reversed direction, an influence of the current flowing through each of the facing radiation fins on a polarized wave is offset. Thereby, deterioration of isolation between two polarized waves in each of the slots 53 is effectively suppressed.

The antenna apparatus 100e according to the fifth modification example can provide an advantageous effect equivalent to that of the antenna apparatus 100. Note that, the heat radiation fin 55 surrounding each of the slots 53 is not limited to a case of being formed into a hexagonal shape when viewed from above, and may be formed into such a polygonal shape as to be point symmetrical about the center of the slot 53 when viewed from above. In addition, understandably, a plurality of slits SL may be provided in the heat radiation fin group 57 provided in the antenna apparatus 100e. In addition, each of the radiation fins 55 may be formed integrally with the heat radiation fin 54 associated with the heat radiation fin 55.

### Second Example Embodiment

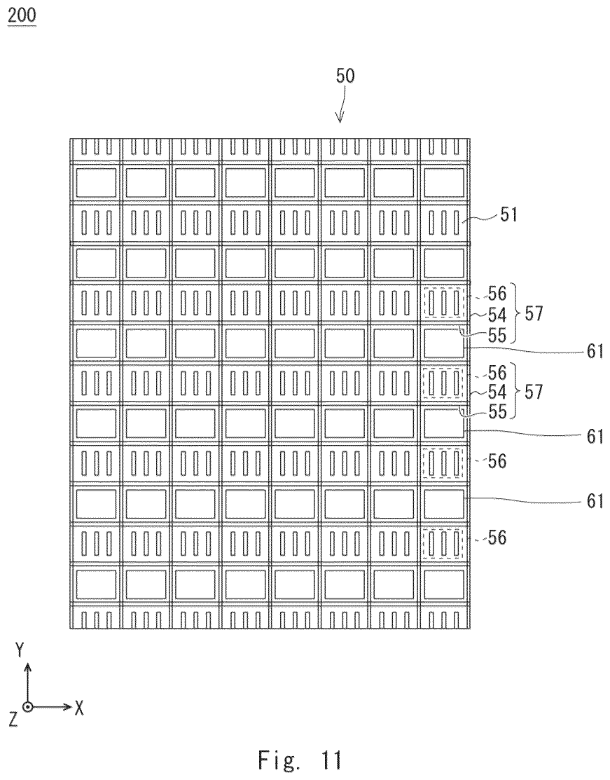

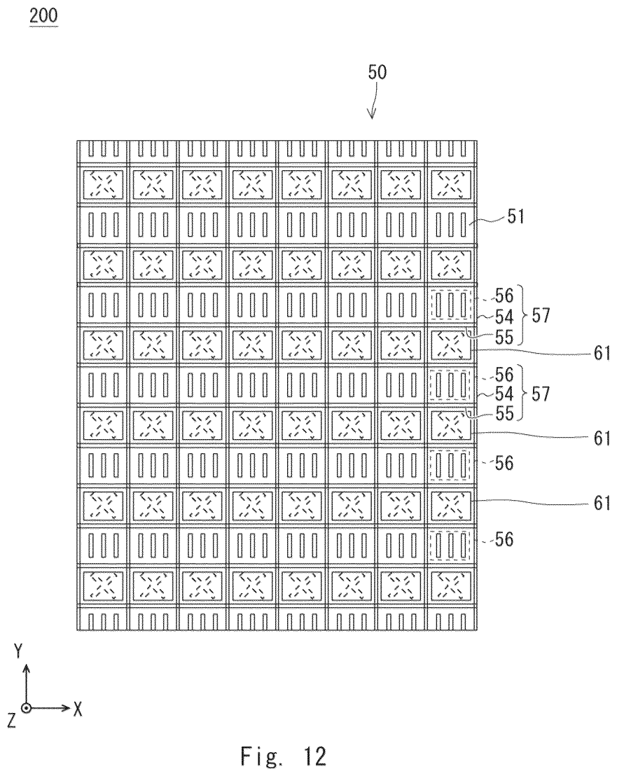

FIGS. 11 and 12 are schematic top views of an antenna apparatus 200 according to a second example embodiment. Note that, in FIG. 12, a hidden slot portion is represented by a broken line. The antenna apparatus 200 further includes a sealing material 61 compared to the antenna apparatus 100.

As illustrated in FIGS. 11 and 12, the sealing material 61 is provided in such a way as to seal each of slots 53 from an outer surface side of a radome 50. The sealing material 61 is made of resin that transmits a radio wave. The sealing material 61 may be formed by filling each of the slots 53 with liquid resin such as silicone. Since a rest of a structure of the antenna apparatus 200 is similar to that of the antenna apparatus 100, description thereof will be omitted.

In this way, the antenna apparatus 200 according to the present example embodiment can provide an advantageous effect equivalent to that of the antenna apparatus 100. Further, in the antenna apparatus 200 according to the present example embodiment, since airtightness inside the apparatus can be improved by sealing each of the slots 53 with the sealing material 61, corrosion and the like inside the apparatus can be prevented.

### Third Example Embodiment

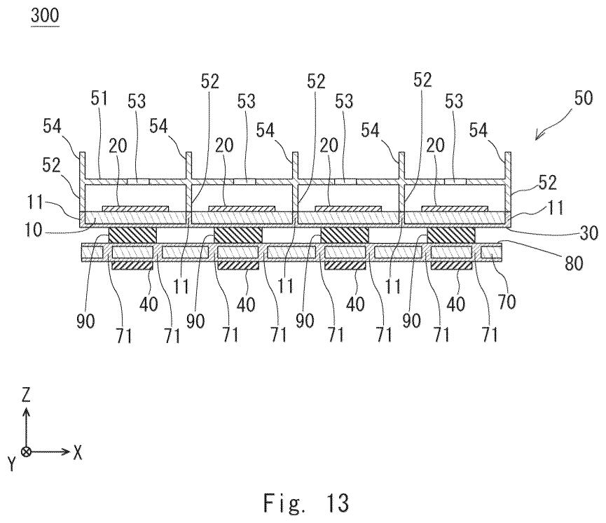

FIG. 13 is a schematic cross-sectional view of an antenna apparatus 300 according to the third example embodiment. Note that, the schematic cross-sectional view of the antenna apparatus 300 illustrated in FIG. 13 corresponds to the schematic cross-sectional view of the antenna apparatus 100 illustrated in FIG. 3.

As illustrated in FIG. 13, compared to the antenna apparatus 100, the antenna apparatus 300 further includes a substrate 70, a ground layer 80, and a plurality of heat transfer members 90. Specifically, the antenna apparatus 300 includes substrates 10 and 70, a plurality of antenna elements 20, ground layers 30 and 80, a plurality of heat generating components 40, a radome 50, and a plurality of heat transfer members 90.

On a back surface of the substrate 10, instead of the plurality of heat generating components 40, the same number of the plurality of heat transfer members 90 as the number of antenna elements 20 are disposed. Each of the plurality of heat transfer members 90 is disposed at a position associated with each of the plurality of antenna elements 20. Specifically, each of the heat transfer members 90 and the antenna element 20 associated with the heat transfer member 90 are disposed in such a way as to sandwich the substrate 10 in the Z-axis direction.

The substrate 70 is disposed in such a way that a third surface faces the back surface of the substrate 10. In other words, the substrate 70 and the substrate 10 are disposed in such a way as to sandwich the plurality of heat transfer members 90 in a Z-axis direction. Note that, the third surface faces the same direction as a front surface of the substrate 10, and may therefore be referred to as a front surface or a top surface, and a fourth surface of the substrate 70 on the opposite side to the third surface may be referred to as a back surface or a bottom surface.

In the substrate 70, a plurality of thermal vias 71 being through holes penetrating from the front surface to the back surface of the substrate 70 are formed. The plurality of thermal vias 71 are disposed in a vicinity of the plurality of heat generating components 40. In addition, the plurality of thermal vias 71 are formed in such a way as to surround the plurality of heat generating components 40 when viewed from above. Note that, in the present example embodiment, the plurality of thermal vias 71 are formed in such a way as to surround all of the plurality of heat generating components 40, but are not limited thereto, and, for example, may be formed in such a way as to surround some of the plurality of heat generating components 40.

The same number of heat-generating components 40 as the number of antenna elements 20 are disposed on the back surface of the substrate 70 via a ground layer 80 made of copper foil or the like. Each of the plurality of heat generating components 40 is disposed at a position associated with each of the plurality of antenna elements 20. Specifically, each of the heat generating components 40 and the antenna element 20 associated with the heat generating component 40 are disposed in such a way as to sandwich the substrate 10, the heat transfer member 90 associated with the heat generating component 40, and the substrate 70 in the Z-axis direction.

Herein, each of the heat generating components 40 is thermally connected to a heat transfer member 90 associated with the heat generating component 40 via the ground layer 80. In addition, each of the heat transfer members 90 is thermally connected to the radome 50 via the ground layer 30. In other words, the antenna apparatus 300 is configured in such a way that heat generated by each of the heat generating components 40 is transferred to the heat transfer member 90 associated with the heat generating component 40 via the thermal via 71 associated with the heat generating component 40, and the heat of the heat transfer member 90 is transferred to the radome 50 via the thermal via 11 associated with the heat transfer member. Each of the thermal vias 71 serves as a heat radiation path that transfers heat generated by the heat generating component 40 associated with the thermal via 71 to the heat transfer member 90 associated with the thermal via 71. In addition, each of the thermal vias 11 serves as a heat radiation path that transfers heat of the heat transfer member 90 associated with the thermal via 11 to the radome 50.

Note that, although omitted in FIG. 13, each of the heat generating components 40 is connected to an external circuit via at least one of a signal line and a control line other than ground of the substrate 70. Further, a ground pad (GND PAD1) on the back surface of each of the heat generating components 40 or a ground pin (GND Pin) disposed around each of the heat generating components 40 is connected by reflow processing using a surface mount technology (SMT) or the like to a ground pattern surface (GND pattern) on the substrate 70 or a ground terminal portion (GND PAD2) for connecting a ground pin. A connection portion between the grounds is connected to the ground layer 80 not only for electrical grounding but also in order to form a heat radiation path.

Each of the heat transfer members 90 may be, for example, a filter (filter component), a high-frequency coaxial connection line, or the like. When each of the heat transfer members 90 is a filter, each of the heat transfer members 90 may be an RF band pass filter (BPF) having a structure with high thermal conductivity. The RF band pass filter may electrically and thermally connect an RF circuit (not illustrated), a TRX circuit (not illustrated), and a digital circuit (not illustrated) disposed on the substrate 70 to the antenna element 20 disposed on the substrate 10. In other words, the RF band pass filter may be effectively utilized both in an electrical circuit manner and in a heat radiation path manner between the RF circuit, TRX circuit, and the digital circuit, and each of the antenna elements 20.

In addition, when each of the heat transfer members 90 is a high-frequency coaxial connection line, a filter is mounted on the bottom surface of the substrate 10. Then, by using, according to an operating frequency band, a frequency dependent substrate 10 in exchange for the substrate 70 on which a transceiver for a frequency common use (not illustrated) is disposed, it can be used as a configuration capable of frequency common use.

Note that, in order to improve heat transfer efficiency, a heat transfer sheet may be disposed between the substrate 10 and the plurality of heat transfer members 90, or between the plurality of heat transfer members 90 and the substrate 70.

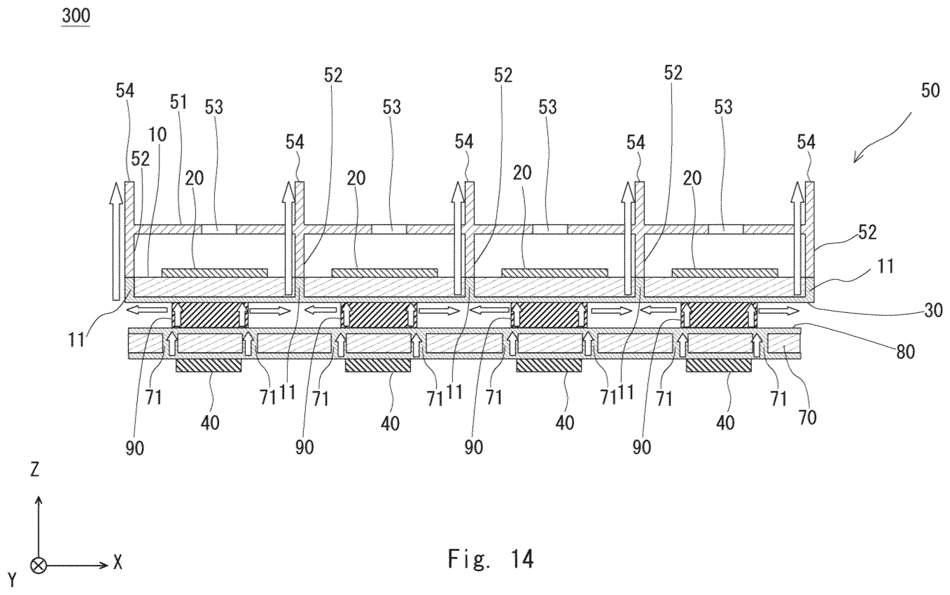

Next, a flow of heat radiation in the antenna apparatus 300 will be described by using FIG. 14. FIG. 14 is a diagram for describing a flow of heat radiation in the antenna apparatus 300. FIG. 14 is a diagram adding a white arrow illustrating a flow of heat generated by the plurality of heat generating components 40 to a schematic cross-sectional view illustrated in FIG. 13. As illustrated in FIG. 14, heat generated in the plurality of heat generating components 40 is transferred to the plurality of heat transfer members 90 via the ground layer 80 and the plurality of thermal vias 71. Thereafter, the heat of the plurality of heat transfer members 90 is transferred to a wall portion 52 of the radome 50 with thermal conductivity via the ground layer 30 and the plurality of thermal vias 11. Thereafter, the heat of the wall portion 52 is transferred to the heat radiation fin group 57 formed on the front surface of the radome 50, and is then radiated to the outside.

The antenna apparatus 300 according to the present example embodiment can provide an advantageous effect equivalent to that of the antenna apparatus 100 and the antenna apparatus 200. In other words, the antenna apparatus 300 according to the present example embodiment includes the radome 50 of a conductor with thermal conductivity that protects the plurality of antenna elements 20 and also functions as a slot antenna. Herein, the radome 50 includes at least the wall portion 52 that receives heat generated within the antenna apparatus 300, and the heat radiation fin group (heat radiation fin structure) 57 that radiates, to the outside, the heat received by the wall portion 52. Thereby, the antenna apparatus 300 according to the present example embodiment can efficiently radiate heat generated within the apparatus to the outside, without providing a heat radiation mechanism in addition to the radome 50. In other words, the antenna apparatus 300 according to the present example embodiment can efficiently radiate heat generated within the apparatus to the outside while suppressing an increase in scale.

In addition, in the antenna apparatus 300 according to the present example embodiment, the heat radiation fin group 57 includes at least a radiation fin formed in such a way as to surround each of the slots 53. Thereby, since a direction of current generated in the vicinity of each of the slots 53 is dispersed, an unintended fluctuation in a direction of a polarized wave transmitted and received in each of the slots 53 due to the current is suppressed. In particular, in each of the slots 53, since transmission and reception of two polarized waves are performed, an unintended fluctuation in directions of the two polarized waves is suppressed, and the directions of the two polarized waves are kept in an orthogonal state, and, thereby, deterioration of isolation between two polarized waves is suppressed.

Note that, the present disclosure is not limited to the above-described example embodiments, and can be appropriately modified without departing from a scope of the present disclosure. Further, the present disclosure may be implemented by appropriately combining each of the example embodiments.

In addition, some or all of the above-described example embodiments may be described as the following supplementary notes, but are not limited thereto.

(Supplementary note 1)

An antenna apparatus including:
a substrate;
an antenna element disposed on a front surface of the substrate; and
a radome of a conductor with thermal conductivity, being configured to cover the front surface of the substrate, and having a slot formed at a position facing the antenna element, wherein
the radome includes a heat radiation fin structure formed in such a way as to protrude from an outer surface on an opposite side to the substrate side, and
the heat radiation fin structure includes at least a heat radiation fin formed in such a way as to surround the slot.
   (Supplementary note 2)

The antenna apparatus according to supplementary note 1, wherein the heat radiation fin is formed in such a way as to be point symmetrical about a center portion of the slot when viewed from above.

(Supplementary note 3)

The antenna apparatus according to supplementary note 1 or 2, wherein the heat radiation fin is formed in one of a polygonal shape and a circular shape when viewed from above.

(Supplementary note 4)

The antenna apparatus according to any one of supplementary notes 1 to 3, wherein the heat radiation fin has one or more slits.

(Supplementary note 5)

The antenna apparatus according to any one of supplementary notes 1 to 4, wherein the slot is formed by intersecting a first opening extending in a first direction and a second opening extending in a second direction different from the first direction.

(Supplementary note 6)

The antenna apparatus according to supplementary note 5, wherein both ends of each of the first opening and the second opening are widened.

(Supplementary note 7)

The antenna apparatus according to any one of supplementary notes 1 to 6, wherein the radome further includes a wall portion protruding from a surface on the substrate side to a front surface of the substrate.

(Supplementary note 8)

An antenna apparatus including:
a substrate;
a plurality of antenna elements disposed on a front surface of the substrate; and
a radome of a conductor with thermal conductivity, being configured to cover the front surface of the substrate, and having a plurality of slots each formed at a position facing each of the plurality of antenna elements, wherein
the radome includes a heat radiation fin structure formed in such a way as to protrude from an outer surface on an opposite side to the substrate side, and
the heat radiation fin structure includes at least a plurality of heat radiation fins each formed in such a way as to surround each of the plurality of slots.
   (Supplementary note 9)

The antenna apparatus according to supplementary note 8, wherein each of the heat radiation fins is formed in such a way as to be point symmetrical about a center portion of the slot associated with the heat radiation fin when viewed from above.

(Supplementary note 10)

The antenna apparatus according to supplementary note 8 or 9, wherein each of the heat radiation fins is formed in one of a polygonal shape and a circular shape when viewed from above.

(Supplementary note 11)

The antenna apparatus according to any one of supplementary notes 8 to 10, wherein each of the heat radiation fins has one or more slits.

(Supplementary note 12)

The antenna apparatus according to any one of supplementary notes 8 to 11, wherein each of the slots is formed by intersecting a first opening extending in a first direction and a second opening extending in a second direction different from the first direction.

(Supplementary note 13)

The antenna apparatus according to supplementary note 12, wherein both ends of each of the first opening and the second opening are widened.

(Supplementary note 14)

The antenna apparatus according to any one of supplementary notes 8 to 13, wherein the radome further includes a wall portion protruding from a surface on the substrate side to a front surface of the substrate.

(Supplementary note 15)

A radome of a conductor with thermal conductivity, having a slot formed at a position facing an antenna element in a state of covering a front surface of a substrate on which the antenna element is disposed,
the radome including a heat radiation fin structure formed in such a way as to protrude from an outer surface on an opposite side to the substrate side,
the heat radiation fin structure including
at least a heat radiation fin formed in such a way as to surround the slot.
   (Supplementary note 16)

The radome according to supplementary note 15, wherein the heat radiation fin is formed in such a way as to be point symmetrical about a center portion of the slot.

(Supplementary note 17)

The radome according to supplementary note 15 or 16, wherein the heat radiation fin is formed in one of a polygonal shape and a circular shape when viewed from above.

(Supplementary note 18)

The radome according to any one of supplementary notes 15 to 17, wherein the heat radiation fin has one or more slits.

(Supplementary note 19)

The radome according to any one of supplementary notes 15 to 18, wherein the slot is formed by intersecting a first opening extending in a first direction and a second opening extending in a second direction different from the first direction.

(Supplementary note 20)

The radome according to supplementary note 19, wherein both ends of each of the first opening and the second opening are widened.

(Supplementary note 21)

The antenna apparatus according to any one of supplementary notes 8 to 13, wherein the radome further includes a wall portion protruding from a surface on the substrate side to a front surface of the substrate.

Although the invention of the present application has been described with reference to the example embodiments, the invention of the present application is not limited to the above. Various modifications that can be understood by a person skilled in the art can be made to the configuration and details of the invention of the present application within the scope of the invention.

### REFERENCE SIGNS LIST

10 SUBSTRATE
11 THERMAL VIA
20 ANTENNA ELEMENT
30 GROUND LAYER
40 HEAT GENERATING COMPONENT
50 RADOME
51 PLANAR PORTION
52 WALL PORTION
53 SLOT
53a FIRST OPENING
53b SECOND OPENING
53c END PORTION
53d END PORTION
53e END PORTION
53f END PORTION
54 FIRST HEAT RADIATION FIN
55 SECOND HEAT RADIATION FIN
56 THIRD HEAT RADIATION FIN
57 HEAT RADIATION FIN GROUP
61 SEALING MATERIAL
70 SUBSTRATE
71 THERMAL VIA
80 GROUND LAYER
90 HEAT TRANSFER MEMBER
100 ANTENNA APPARATUS
100a to 100e ANTENNA APPARATUS
200 ANTENNA APPARATUS
300 ANTENNA APPARATUS

What is claimed is:

1. An antenna apparatus comprising:
a substrate;
an antenna element disposed on a front surface of the substrate; and
a radome of a conductor with thermal conductivity, being configured to cover the front surface of the substrate, and having a slot formed at a position facing the antenna element, wherein
the radome includes a heat radiation fin structure formed in such a way as to protrude from an outer surface on an opposite side to the substrate side, and
the heat radiation fin structure includes at least a heat radiation fin formed in such a way as to surround the slot.

2. The antenna apparatus according to claim 1, wherein the heat radiation fin is formed in such a way as to be point symmetrical about a center portion of the slot when viewed from above.

3. The antenna apparatus according to claim 1, wherein the heat radiation fin is formed in one of a polygonal shape and a circular shape when viewed from above.

4. The antenna apparatus according to claim 1, wherein the heat radiation fin has one or more slits.

5. The antenna apparatus according to claim 1, wherein the slot is formed by intersecting a first opening extending in a first direction and a second opening extending in a second direction different from the first direction.

6. The antenna apparatus according to claim 5, wherein both ends of each of the first opening and the second opening are widened.

7. The antenna apparatus according to claim 1, wherein the radome further includes a wall portion protruding from a surface on the substrate side to a front surface of the substrate.

8. An antenna apparatus comprising:
a substrate;
a plurality of antenna elements disposed on a front surface of the substrate; and
a radome of a conductor with thermal conductivity, being configured to cover the front surface of the substrate, and having a plurality of slots each formed at a position facing each of the plurality of antenna elements, wherein
the radome includes a heat radiation fin structure formed in such a way as to protrude from an outer surface on an opposite side to the substrate side, and
the heat radiation fin structure includes at least a plurality of heat radiation fins each formed in such a way as to surround each of the plurality of slots.

9. The antenna apparatus according to claim 8, wherein each of the heat radiation fins is formed in such a way as to be point symmetrical about a center portion of the slot associated with the heat radiation fin when viewed from above.

10. The antenna apparatus according to claim 8, wherein each of the heat radiation fins is formed in one of a polygonal shape and a circular shape when viewed from above.

11. The antenna apparatus according to claim 8, wherein each of the heat radiation fins has one or more slits.

12. The antenna apparatus according to claim 8, wherein each of the slots is formed by intersecting a first opening extending in a first direction and a second opening extending in a second direction different from the first direction.

13. The antenna apparatus according to claim 12, wherein both ends of each of the first opening and the second opening are widened.

14. The antenna apparatus according to claim 8, wherein the radome further includes a wall portion protruding from a surface on the substrate side to a front surface of the substrate.

15. A radome of a conductor with thermal conductivity, having a slot formed at a position facing an antenna element in a state of covering a front surface of a substrate on which the antenna element is disposed,
the radome comprising a heat radiation fin structure formed in such a way as to protrude from an outer surface on an opposite side to the substrate side,
the heat radiation fin structure including at least a heat radiation fin formed in such a way as to surround the slot.

16. The radome according to claim 15, wherein the heat radiation fin is formed in such a way as to be point symmetrical about a center portion of the slot.

17. The radome according to claim 15, wherein the heat radiation fin is formed in one of a polygonal shape and a circular shape when viewed from above.

18. The radome according to claim 15, wherein the heat radiation fin has one or more slits.

19. The radome according to claim 15, wherein the slot is formed by intersecting a first opening extending in a first direction and a second opening extending in a second direction different from the first direction.

20. The radome according to claim 19, wherein both ends of each of the first opening and the second opening are widened.

21. (canceled)
